(19) United States
(12) Patent Application Publication
(10) Pub. No.: US 2005/0022654 A1
(43) Pub. Date: Feb. 3, 2005

(54) Universal song performance method

(76) Inventors: George R. Petersen, Alameda, CA (US); James K. Jenkins, Alameda, CA (US)

Correspondence Address: Mr. George Patersen, P.O. Box 2542, Alameda, CA, 94501, US

(21) Appl. No.: 10/629,363

(22) Filed: Jul. 29, 2003

(51) Int. Cl. G10H 1/00

(52) U.S. Cl. 84/600

(57) ABSTRACT

A melodic interchange system that allows persons having no previous musical training or musical sight-reading skill to perform new lyrical contents. Known as the Universal Song Performance Method (USPM), this process capitalizes on the user's existing knowledge of a plurality of well-known melodies—ranging from simple nursery rhymes (that anyone would know) to elaborate classical works. The USPM system is comprised of printed or otherwise visually displayed text containing newly-authored, structured rhythmic prosody based on common-mode scansion that is divisible within a standard musical form, thus enabling said lyrics to be superimposed over melodic material that is familiar to the user.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A SEQUENCE LISTING, A TABLE, OR A COMPUTER PROGRAM LISTING COMPACT DISC APPENDIX

Not applicable.

### BACKGROUND OF THE INVENTION

Since the ability to read musical notes is a difficult and laborious process to master, the vast majority of the populace are essentially musically illiterate. As a result of this situation, new compositions in printed form only appeal to an extremely small segment of society. Over the years, numerous systems have been proposed as a solution to this problem, often employing visual aids or methods such as co-numbering/lettering or color-coded markings or icons on sheet music, with corresponding markers or icons affixed to an instrument's keys thus enabling performance via matching systems that do not depend on a user's ability to read and interpret the correct pitch and note durations of standard musical notation. These approaches can also employ various mechanical and/or electronic devices in their methodology. A few examples of such systems include: U.S. Pat. No. 5,540,132; U.S. Pat. No. 5,998,720; U.S. Pat. No. 6,288,315; U.S. Pat. No. 6,388,182; and U.S. Pat. No. 6,407,323.

Just as poetic writings can be analyzed and divided into metrical patterns (scansion), musical melodies can similarly be divided. However, unlike song lyrics, poetic verse is not restricted by linear time constraints, so a common mode of scansion cannot be achieved. Music is a unique language, in that—unlike any other spoken or communicative written language in the world—it is by nature, a wholly time-based system. A time-based entity, music is built upon the concept that the individual segments—or notes—that make up the system are mathematically divisible in a multitude of combinations, although they must ultimately conform to linear time constraints. Due to this limiting parameter of time, there is a finite combination of time-assigned notes that can be used within individual measures, phrases, and entire song structures.

Years of analyzing a variety of musical forms led to our unexpected discovery of common links—a number of universal structures used in a majority of the popular music forms created over the past 400 years. We defined these rhythmic structures into what we term “common-mode” scansions. Our further research into the utility of this phenomenon offered new and unexpected results, wherein collections of newly-authored song lyrics following our common-mode scansion models could be applied to thousands of existing melodies. This Universal Song Performance Method provides a simple, unobvious solution to an age-old problem, by allowing fresh, original lyrics to be easily performed by individuals who may lack formal musical education.

In the past, prior art has touched upon several of the components employed in our USPM process. Among these were Campbell Allen's 1874 “Improvement in the Syllabication of Words” (U.S. Pat. No. 146,631), which used a scansion-style approach to enhance a child's ability to understand word syllabication. Imogen B. Oakley's 1887 “Kindergarten Game for Teaching Spelling” (U.S. Pat. No. 364,845) used a book with recognizable pictures that anyone would know, combined with simple words relating to those images to improve a non-reading student's ability to spell. Taking that concept further was Willard D. Smith's “Educational Art and Apparatus” (U.S. Pat. No. 2,524,143), which proposed an improved reading teaching method using printed materials with the words to simple stories, combined with recorded disks having those same words read to a rhythmical background sound. Although each of these share certain aspects with our Universal Song Performance Method, these elementary techniques have never previously been used as a component of a simplified process for the performance of song lyrics, such as USPM.

### BRIEF SUMMARY OF THE INVENTION

The Universal Song Performance Method (USPM) is a melodic interchange system representing a fundamental revolution that will forever change the way that music is written and performed. Our research into the existence of common rhythmic patterns among songs revealed the novel and quite unexpected result that collections of newly-authored song lyrics following our common-mode scansion models could be applied to thousands of existing melodies. In the most basic terms, USPM essentially allows persons having no previous musical training or musical sight-reading skill to perform new lyrical compositions. This universal song interchange process had never been envisioned in any prior art and the novelty of our method succeeds in ways that previous systems could not. USPM capitalizes on the user's existing knowledge of well-known melodies—ranging from simple nursery rhymes (that anyone would know) to elaborate classical works. In effect, this creates a universal song interchange system that allows new lyrics to be readily performed by persons having no musical training or knowledge. The result is an easy-to-use, yet unobvious solution to a long-felt need.

### BRIEF DESCRIPTION OF THE SEVERAL VIEWS OF THE DRAWING

Not applicable.

### DETAILED DESCRIPTION OF THE INVENTION

Note: Parts of the disclosure within this patent document contains material that is subject to protection under U.S. copyright law. The copyright owner(s) have no objection to the facsimile reproduction of the patent disclosure as it appears in the Patent & Trademark Office, patent files or records, but otherwise reserves all copyright rights whatsoever.

Years of analyzing a variety of musical forms led to our unexpected discovery of common links—a number of universal structures used in a majority of the popular music forms created over the past 400 years. We defined these rhythmic and rhyming schemes into what we term “common-mode” scansions, falling into basic categories such as “Gregorian,” “Sino-Asian,” “Homeric,” “Western” and “Neo-Western” and a handful of other lesser-known styles. This research into common-mode scansions that encompass the entirety of the music catalog of the world and its many cultures is a lengthy, ongoing process. For the purposes of this patent, we will address only those two groups of common-mode scansions that pertain to this body of work. These two groups are the “Western” and “Neo-Western” common-mode scansions. These two common-mode scansions comprise some 40% of all Western European and North American vocal music written, starting in the 17th century and continuing to the present.

Taken as a whole, the existence of common rhythmic patterns among songs is little more than an interesting academic exercise. However, our further research into this phenomenon revealed the novel and quite unexpected result that collections of newly-authored song lyrics following our common-mode scansion models could be applied to thousands of existing melodies. In effect, this creates a universal song interchange system that allows new lyrics to be easily performed by persons having no musical training or knowledge. The result is an easy-to-use, yet unobvious solution to a long-felt need.

For example, as a means of encouraging music participation, children are often provided with texts containing traditional musical material that lyrically is uninteresting to them and largely irrelevant to modern society, such as whaling songs. Certainly there is no shortage of new compositions; however, if the students are unable to read music notation, they cannot perform these new songs. By applying new lyrical compositions to existing songs—representing more than 40% of Western popular music—a near-unlimited combination of varying song structures can be made by superimposing said new lyrics that are written utilizing a common-mode scansion.

For example, consider these examples, using the songs “Summer Heat” and “My Cat,” which were newly-written by the inventors in this patent, following our common-mode scansion model that allows these words to be used with an almost unlimited number of existing melodies.

My Cat
We got a kitty yesterday.
She loves to roll around and play.
The other cats don't like her here.
When she comes in, they disappear.
She ate my shoes. She ate my socks
And then filled up the litterbox.
Mom says her food will cost a lot.
What do you feed an ocelot?
© 2003, JENPET MUSIC, Used by Permission

Summer Heat
There's nothing worse than summer heat.
It make you sweat and burns your feet.
The asphalt boils and stop signs bend
And people shout: “When will it end?”
The Weather Channel says “Prepare:
More heat to come than you can bear!”
This heat's not bad to me because,
I live next door to Santa Claus!
© 2003, JENPET MUSIC, Used by Permission

While the two above songs represent new and original lyrics, they can easily be performed to a vast number of TRADITIONAL tunes, such as the 50 sample song titles listed below:

“A Man of Constant Sorrow”; “Amazing Grace”; “America the Beautiful”; “Anchors Aweigh”; “Auld Lange Syne”; “Away in a Manger”; “Beautiful Dreamer”; “Blow Ye Winds”; “Casey Jones”; “Deck the Halls”; “Doxology”; “Good King Wenceslaus”; “Greensleeves”; “House of the Rising Sun”; “I've Been Working on the Railroad”; “Jingle Bells”; “Kumbaya”; “La Cucharacha”; “La Donna e Mobile”; “Little Brown Jug”; “Loch Lomond”; “London Bridge is Falling Down”; “Mary had a Little Lamb”; “Mexican Hat Dance”; “My Darling Clementine”; “My Dreidel”; “Ninety-Nine Bottles of Beer”; “O Little Town of Bethlehem”; “Old Gray Mare”; “Old Time Religion”; “O Sole Mio”; “Reuben, Reuben”; “Rock a Bye Baby”; “Rock My Soul”; “Row, Row, Row Your Boat”; “Scarborough Fair”; “Shalom Alechim”; “Sinner Man”; “Star-Spangled Banner, The”; “Stars & Stripes Forever”; “Swanee River”; “Swing Low, Sweet Chariot”; “Ta Ra Ra Boom De Ay”; “This Old Man”; “US Marines Song”(Halls of Montezuma); “Viva la Compagnie”; “We Three Kings”; “What Shall we do With a Drunken Sailor?”; “When the Saints Go Marching In”; “Wildwood Flower”; and “You are My Sunshine”.

This Universal Song Performance Method (USPM) of melodic interchange using common-mode scansion is not limited to older songs. In fact, the lyrics to the above songs above can just as easily be performed to more CONTEMPORARY material, such as the 50 well-known examples listed below:

“Addams Family” TV theme; “Ballad of the Green Berets”; “Barney Song, The”; “Barnacle Bill The Sailor”; “Battle of New Orleans”; “Beverly Hillbillies” theme; “Chipmunk Song, The”; “Crocodile Rock”; “Do-Re-Mi”; “Eidelweiss”; “Freight Train”; “From Me to You”; “Happy Birthday”; “He's Got the Whole World in His Hands”; “Here Comes Santa Claus”; “Hokey Pokey, The”; “If You Wanna be Happy”; “I'm Henry the Eighth, I Am”; “In My Life”; “Itsy Bitsy Spider”; “I Love Lucy” theme; “Jamaica Farewell”; “Jeopardy” TV show theme; “King of the Road”; “Last Night I had the Strangest Dream”; “Light My Fire”; “Lord of the Dance”; “Love Me Tender”; “Michael Row the Boat”; “Puff, the Magic Dragon”; “Purple Haze”; “Spiderman” TV show theme; “Spinning Wheel”; “Summertime”; “Sweet Home Alabama”; “Take Me Home, Country Roads”; “This Land is Your Land”; “Tom Dooley”; “Up on the Rooftop”; “US Air Force Song” (Off we go . . . ); “Wheels on the Bus, The”; “When I'm 64”; “When You Wish Upon a Star”; “Whistle While You Work”; “Who's Afraid of the Big Bad Wolf?”; “Winter Wonderland”; “Wouldn't it be Loverly?”; “You are the Sunshine of My Life”; “You're in the Army Now”; and “Zip-a-de-do-da”.

It should be noted that the above songs—and the melodies listed with them—are examples of “Western” (16-measures/verse) scansion. The other predominant mode (used primarily in rock and blues musical forms) is what we've defined as “Neo-Western” scansion, which is based around 12-measure verses. Here again, the common-mode scansion applies (albeit in a different mode—it is simply that the lyrics are shorter and designed to fit the constraints of the 12-measure framework.

By utilizing these common-mode scansions, new and original lyrical content can be produced that can be used with existing melodies.

It should also be noted that song parodies—which in some ways, may be similar to the Universal Song Performance Method outlined here—are in many respects quite different. Song parodies are nothing new—in fact, they can be traced to the earliest times, as evidenced by the many variations on songs such as the “Twelve Days of Christmas” or “The Ants Go Marching.” Song parodies are typically written to mimic the lyrical structure of a particular tune and often contain phrases, wordings or entire stanzas taken from the original. It is also important to note that song parodies are inflexible in structure and made to exactly fit the melodic phrasing and prosody of the song being parodied and are not designed to be used with other melodies, unlike songs composed using the USPM system.

Certainly, another common practice through the years is the “recycling” of melodies, where new lyrics are added over existing tunes to create new songs. Among the best known examples of this are songs such as “Greensleeves” /“What Child is This,” “My Country 'tis of Thee” /“God Save the Queen” and even “The Star Spangled Banner,” which hails from “To Anacreon in Heaven,” a much earlier tune.

But here again, it must be emphasized that these “recyclings” represent specific new lyrics written to fit a discrete song structure, and were not designed—or even envisioned—to be used with other melodic configurations.

By contrast, lyrics written within the parameters of the Universal Song Performance Method process are designed—and intended—to be used with a vast number of melodies, with the novel and quite unexpected result that collections of newly-authored song lyrics following our common-mode scansion models could be applied to thousands of existing melodies.

USPM is not limited by other methods' barriers of language fluency (and/or proficiency) or cultural background. Its unique methodology is equally applicable to persons speaking English, Spanish, French, German or any other language, as long as the lyrical constructs adhere to our common-mode scansion model. Additionally, USPM works equally well in a variety of musical genres and styles, as diverse as folk, classical, opera, hymns, nursery songs, and more contemporary forms, such as country, rock and rap.

The scope of the Universal Song Performance Method is extraordinarily wide, applying itself equally well in formats such as: textual material(s) in book or electronic form, whether as traditional paper-bound books, cards, leaflets and/or song-sheets, or as electronic media—i.e., CDs, CD-ROMs, DVD-A, DVD-V, SACD, DVD-ROMs, Internet files, videotapes, diskettes, encoded ROM/RAM chips for solid-state storage/playback devices, mixed media disks—such as interactive computer files combined with instrumental musical compositions in audio and/or MIDI (Musical Instrument Digital Interface) formats, Karaoke-style disks/files and the like.

It should be further emphasized that the Universal Song Performance Method applies to a wide range of applications, not only as entertainment forms such as musical performance books/devices and Karaoke systems, electronic toys and computer games, but also educational devices and teaching methods, both non-musical (such as mnemonics and memorization routines) as well as in music education. USPM systems can exist in both audio/visual as well as standard printed formats (which, if desired, the latter can be combined with prerecorded instrumental melodic files) for encouraging musical activities among students. By exposing students that may be difficult to reach using traditional musical training methods to new lyrical material combined with familiar melodies that are known to the listener, the student's acceptance to new musical forms is significantly enhanced.

In the most basic terms, the Universal Song Performance Method allows persons having no previous musical training or musical sight-reading skill to perform new lyrical compositions. This universal song interchange process had never been envisioned in any prior art and the novelty of our method succeeds in ways that previous systems could not. USPM capitalizes on the user's existing knowledge of well-known melodies—ranging from simple nursery rhymes (that anyone would know) to elaborate classical works. In effect, this creates a universal song interchange system that allows new lyrics to be readily performed by persons having no musical training or knowledge, providing a simple—yet unobvious—solution to an age-old need.

1. A melodic interchange process, which we have named the Universal Song Performance Method (hereafter also referred to as USPM) that is grounded in our discovery of common-mode scansions—essentially common rhythmic links existing between otherwise dissimilar musical works. USPM uses new, original written text (printed or otherwise visually displayed) containing a plurality of structured rhythmic prosody employing common-mode scansion that is divisible within a standard musical form, thus allowing persons having no previous musical training or musical sightreading skill to perform newly-authored lyrical creations.

2. The method according to claim 1, wherein: the Universal Song Performance Method is designed with written/displayed text(s) containing rhythmic prosody structured on common-mode scansion, thus enabling said new lyrics to be superimposed over melodic material that is familiar to the user. These can exist as a single (or a plurality of) short or long lyrical piece(s), combined with a textual song list and/or sound playback system containing instrumental compositions that follow the same common-mode scansion as the lyrics.

3. The method according to claim 2, wherein: this system capitalizes on the user's knowledge of well-known melodies—ranging from simple nursery rhymes (that anyone would know) to elaborate classical works that are previously known to the user. By authoring new lyrics to the USPM model, the resulting lyrics can be performed with thousands of existing tunes.

4. The method according to claim 2, includes formats such as: textual material(s) in book or electronic form, whether as traditional paper-bound books, cards, leaflets and/or song-sheets, or as electronic media—i.e., CDs, CD-ROMs, DVD-A, DVD-V, SACD, DVD-ROMs, Internet files, videotapes, diskettes, encoded ROM/RAM chips for solid-state storage/playback devices, mixed media disks—such as interactive computer files combined with instrumental musical compositions in audio and/or MIDI (Musical Instrument Digital Interface) formats, Karaoke-style disks/files and the like.

5. USPM applications include use as an entertainment form—such as electronic toys/games, musical performance books/devices and Karaoke systems.

6. USPM applications further include: musical educational devices and teaching methods in both audio/visual as well as traditional book formats (which, if desired, can be combined with prerecorded instrumental melodic files) for encouraging musical activities among students.

7. The method in claim 6, further including: students, both in at-grade levels, as well as those who are developmentally disabled or difficult to reach using traditional musical training methods. By exposing students to new lyrical material combined with familiar melodies that are known to the listener, the student's acceptance to new musical forms is enhanced significantly.

8. USPM applications include not only entertainment and music-education systems, but also can be employed in the instruction of NON-musical subjects, such as use in mnemonics systems. In such cases, the memory of lists, facts, names or other difficult-to-recall material can be enhanced using non-lyrical phrases put into a common-mode scansion style and combined with familiar existing melodies.

9. USPM is not limited by other methods' barriers of language fluency (and/or proficiency) or cultural background. Its unique methodology is equally applicable to persons speaking English, Spanish, French, German or any other language, as long as the lyrical constructs adhere to our common-mode scansion model. Additionally, USPM works equally well in a variety of musical genres and styles, as diverse as folk, classical, opera, hymns, nursery songs, and more contemporary forms, such as country, rock and rap.
